(19) United States
(12) Patent Application Publication
(10) Pub. No.: US 2006/0147093 A1
(43) Pub. Date: Jul. 6, 2006

(54) ID card generating apparatus, ID card, facial recognition terminal apparatus, facial recognition apparatus and system

(76) Inventors: Takashi Sanse, Tokyo (JP); Satoshi Seto, Kanagawa-ken (JP)

Correspondence Address: BIRCH STEWART KOLASCH & BIRCH, PO BOX 747, FALLS CHURCH, VA, 22040-0747, US

(21) Appl. No.: 10/790,787

(22) Filed: Mar. 3, 2004

(30) Foreign Application Priority Data
Mar. 3, 2003 (JP) 055341/2003
Sep. 9, 2003 (JP) 316593/2003

(51) Int. Cl. G06K 9/00

(52) U.S. Cl. 382/115

(57) ABSTRACT

A photo ID card, which is difficult to forge, is generated. A photo ID card having an IC chip is generated, and a face photo area therein is photographed for obtaining face photo data. The face photo data are converted into code information and stored in the chip together with personal information. For authentication, the face of a person being authenticated is photographed for obtaining photographed face data, and converted into code information. The personal information and the code information is read from the chip of the card held by the person, and whether or not the information obtained by the reading has been registered with a registration server is judged. Whether or not the code information generated from the photographed face data agrees with the code information in the server is also judged. If the results of both judgments are affirmative, the person is authenticated.

### BACKGROUND OF THE INVENTION

1. Field of the Invention

The present invention relates to an ID card generation apparatus for generating a photo ID card storing personal information, an ID card, a face authentication terminal, a face authentication apparatus, and a face authentication system.

2. Description of the Related Art

ID cards whereon face photos are printed for identification have been used (see Japanese Unexamined Patent Publication No. 6(1994)-199080). Furthermore, personal information for identifying a person is stored in an ID card, and the personal information is read from the ID card when the person enters or leaves a high-security area or accesses an information system. The person is then authenticated through comparison of the personal information with personal information, which has been pre-registered. As an ID card for storing such personal information, a card having a magnetic strip thereon has been used. However, a so-called IC card has also been proposed, that uses a semiconductor chip for storing personal information.

Recently, a biometric technology has also been proposed for authenticating a person by using biometric information specific to the person such as fingerprints, irises, voiceprints, and faces. In this technique of authentication by using a biometric technology, a person whose biometric information is provided is authenticated or not authenticated as the person through signal processing that automatically compares biometric information such as fingerprints, irises, voiceprints, or faces, which have been pre-registered with the biometric information of the person subjected to authentication. As a face authentication technique, a method using a Gabor filter has been proposed (see Japan Automatic Identification System Association, [Korede wakatta Biometrics (in Japanese)] Ohm-sha, Sep. 10, 2001, p59-71, 120-126).

In the method using the Gabor filter described in the Japan Automatic Identification System Association document, facial feature points such as eyes, nose, and mouth are laid out in a face image, and a Gabor filter having varying resolution and orientation is convolved at each of the feature points. In this manner, feature values are obtained as periodicity and orientation of density change around the feature points. By combining spatial location information of the feature points with the values thereof, a face graph having an elastic relationship of locations is then generated. The face graph is used for detecting a facial position, and the feature points are also detected. By comparing similarity between the feature values and feature values of a pre-registered face around the feature points, a person can be authenticated or not authenticated as the person.

The Japan Automatic Identification System Association document also proposes a method of authenticating a person by storing biometric information as well as personal information in an IC card for authenticating the card itself with the personal information and authenticating the person by the biometric information using a biometric technology. The Japan Automatic Identification System Association document also describes usage of the face as the biometric information. By using both the personal information and the biometric information, security can be double-guarded. Furthermore, if a photo ID card is issued by printing a face photo on an IC card storing personal information and biometric information, face identification by visual inspection can also be carried out, which improves security further.

However, the system described in the Japan Automatic Identification System Association document compares the biometric information obtained from the person as the holder of the IC card at the time of authentication with the biometric information stored in the IC card. Therefore, the person is authenticated if the biometric information of the IC card agrees with the biometric information of the holder. For this reason, if face photo data are obtained by photographing a face and biometric information obtained from the face photo data is stored in an IC card at the same time the face photo data are added to the ID card, the ID card enabling authentication can be forged.

### SUMMARY OF THE INVENTION

The present invention has been conceived based on consideration of the above circumstances. An object of the present invention is therefore to generate a photo ID card that is more difficult to forge.

Another object of the present invention is to enable higher security authentication by using the photo ID card.

An ID card generation apparatus of the present invention comprises:

photography means for obtaining face photo data representing a face photo area of a predetermined format by photographing the face photo area in an ID card comprising the face photo area added with a face photo of the predetermined format and an information storage area for storing various kinds of information including personal information of the person of the face photo;

code conversion means for converting the face photo data into code information; and

code information recording means for storing the code information in the information storage area.

The predetermined format refers to a predetermined face size in the face photo, sizes of areas in right, left, top and bottom of the face in the face photo, and a ratio of a length of a predetermined area in the face photo to a length of the face, for example. In the predetermined format, the face of a predetermined size may be included at a predetermined position in the face photo of a predetermined size as well as distances from edges of the face such as top of the head, tip of the chin, and ears to edges of the face photo are predetermined. The size of the face photo, the size of the face in the face photo, and the sizes from the edges of the face to the edges of the face photo may have an error that is allowed within a predetermined range.

The personal information refers to not only the name, the address, and the phone number of the person in the face photo but also information that cannot be designated by the person such as an employee identification number if the person is a company employee, a student identification number if the person is a student, a membership number if the person is a member of some organization, and a card number if the ID card is an ATM card or a credit card, for example.

The code information is obtained by converting the face photo data, and related to the face photo data one to one. The code information may be characteristic values representing locations of facial features such as eyes, nose, and mouth in the face photo represented by the face photo data, eigenvectors obtained by principal component analysis of the face photo data, eigenvectors of each of the facial features obtained by principal component analysis thereof, and values obtained by quantifying and normalizing face characteristic values extracted as areas having density contrast such as eyes, sides of nose, mouth, eyebrows, and cheeks by using a neural network, for example.

In the ID generation apparatus of the present invention, the face photo added to the face photo area may be obtained by a face extraction apparatus comprising:

photography means for obtaining original image data representing an original image including the face of the person, of whom is being generated, by photographing the face;

eye position detection means for detecting center positions of eyes in the face in the original image;

normalization means for obtaining a normalized original image by normalizing the original image in such a manner that a distance between the center positions of the eyes that have been detected becomes a predetermined value; and

cutting means for obtaining face image data representing the face photo by cutting an image having the predetermined format from the normalized original image with reference to the distance between the center positions of the eyes in the face in the normalized original image.

In the ID card generation apparatus of the present invention, the photography means may comprise:

eye position detection means for detecting center positions of eyes in the face in an original image represented by original image data obtained by photographing the face photo area;

normalization means for obtaining a normalized original image by normalizing the original image in such a manner that a distance between the center positions of the eyes that have been detected becomes a predetermined value; and

cutting means for obtaining the face photo data by cutting an image having the predetermined format from the normalized original image with reference to the distance between the center positions of the eyes in the face in the normalized original image.

An ID card of the present invention comprises:

a face photo area added with a face photo of a predetermined format; and

an information storage area for storing various kinds of information including personal information of the person in the face photo. The ID card of the present invention is characterized by that the information storage area stores code information generated by converting face photo data that are obtained by photographing the face photo area and represents the face photo area of the predetermined format.

In the ID card of the present invention, the face photo added to the face photo area may be obtained by a face extraction apparatus comprising:

photography means for obtaining original image data representing an original image including the face of a person, the ID card of whom is being generated, by photographing the face;

eye position detection means for detecting center positions of eyes in the face in the original image;

normalization means for obtaining a normalized original image by normalizing the original image in such a manner that a distance between the center positions of the eyes that have been detected becomes a predetermined value; and

cutting means for obtaining face image data representing the face photo by cutting an image having the predetermined format from the normalized original image with reference to the distance between the center positions of the eyes in the face in the normalized original image.

A face authentication terminal of the present invention comprises:

photography means for obtaining photographed face data representing a face image of a holder of the ID card of the present invention in the predetermined format by photographing the face of the holder; and

information reading means for reading the personal information and the code information from the information storage area.

The face authentication terminal of the present invention may further comprise display means for displaying various kinds of information including the photographed face data.

In addition, the face authentication terminal of the present invention may further comprise:

registration means for registering personal information and code information of a large number of people;

information judgment means for carrying out judgment as to whether or not correlation personal information and correlation code information respectively corresponding to the personal information and the code information that has been read has been registered with the registration means;

code conversion means for converting the photographed face data into code information;

code judgment means for carrying out judgment as to whether or not the code information obtained by the code conversion means mostly agrees with the correlation code information; and

authentication information output means for outputting authentication information representing that the holder has been authenticated in the case where results of the judgment by the information judgment means and the code judgment means are both affirmative.

In the face authentication terminal of the present invention, the photography means may comprise:

eye position detection means for detecting center positions of eyes in the face in an original image represented by original image data obtained by photography of the face of the holder of the ID card;

normalization means for obtaining a normalized original image by normalizing the original image in such a manner that a distance between the center positions of the eyes that have been detected becomes a predetermined value; and

cutting means for obtaining the photographed face data by cutting an image having the predetermined format from the normalized original image with reference to the distance between the center positions of the eyes in the face in the normalized original image.

A face authentication apparatus of the present invention comprises:

information acquisition means for obtaining the photographed face data, the personal information, and the code information obtained by the face authentication terminal of the present invention;

registration means for registering personal information and code information of a large number of people;

information judgment means for carrying out judgment as to whether or not correlation personal information and correlation code information respectively corresponding to the personal information and the code information that has been obtained has been registered with the registration means;

code conversion means for converting the photographed face data into code information;

code judgment means for carrying out judgment as to whether or not the code information obtained by the code conversion means mostly agrees with the correlation code information; and

authentication information output means for outputting authentication information representing that the holder has been authenticated in the case where results of the judgment by the information judgment means and the code judgment means are both affirmative.

A face authentication system of the present invention is characterized by that:

the face authentication terminal of the present invention; and

the face authentication apparatus of the present invention are connected to each other in a manner enabling transmission and reception of various kinds of information.

The face authentication system of the present invention may further comprise the ID card generation apparatus of the present invention.

The eye position detection means in the face extraction apparatus and the photography means for obtaining in the predetermined format the face image data representing the face photo, the face photo data representing the face photo area, and the photographed face data representing the face image of the holder of the ID card (hereinafter referred to as the face photo and the like) in the ID card generation apparatus, the ID card, and the face authentication terminal of the present invention may comprise:

characteristic value calculation means for calculating at least one characteristic value used for detecting the center positions of the eyes from the original image; and

recognition means for recognizing the center positions of the eyes in the face included in the original image by referring to reference data defining in advance the characteristic value or values and at least one recognition condition corresponding one to one to the characteristic value or values, based on the characteristic value or values calculated from the original image. The reference data are obtained by learning in advance the characteristic value or values included in a sample image group comprising face sample images wherein the center positions and/or a location relationship of the eyes have been normalized and non-face sample images according to a machine learning method.

The characteristic value refers to a parameter representing a characteristic of an image. The characteristic may be any characteristic, such as a gradient vector representing a gradient of density of pixels in the image, color information (such as hue and saturation) of the pixels, density, a characteristic in texture, depth information, and a characteristic of an edge in the image.

The recognition condition refers to a condition for recognizing the center positions of the eyes, based on the characteristic value or values.

The machine learning method can be any known method such as one that employs a neural network and boosting.

In the ID card generation apparatus of the present invention, the face photo area in the ID card added with the face photo of the predetermined format is photographed, and the face photo data representing the face photo having the predetermined format are obtained. The face photo data are then converted into the code information, and the code information is stored in the information storage area of the ID card. The ID card generated in this manner is used as the ID card of the present invention. Therefore, by registering the code information obtained by conversion of the face photo data, even if the face photo in the ID card is forged or code information obtained from face photo data of a forger is stored in the information storage area, the code information stored in the information storage area does not agree with the registered code information. Therefore, the forger cannot be authenticated. Furthermore, even if an ID card is forged by changing the face photo area of the ID card of the present invention, the code information obtained by converting the face photo data though photography of the face photo area of the ID card does not agree completely with the code information stored in the information storage area or the registered code information even if the forger is the person in the authentic ID card. Therefore, the forgery of the ID card can be recognized easily. In this manner, an ID card, which is difficult to forge, can be generated according to the present invention.

Furthermore, since the code information obtained by conversion of the face photo data is stored in the information storage area, capacity of the information storage area can be smaller than in the case of storing the face photo data themselves in the information storage area. Therefore, the ID card can be prevented from becoming expensive due to usage of an information storage area having large capacity.

The face authentication terminal of the present invention obtains the photographed face data representing the face image including the face of the holder of the ID card in the same predetermined format as the face image data used for generation of the ID card, by photographing the face of the holder of the ID card of the present invention. The personal information and the code information is also read from the information storage area. Therefore, all the information necessary for authenticating the holder of the ID card of the present invention can be obtained.

Furthermore, the face authentication terminal, as will be recited in Claim 8, judges whether or not the correlation personal information and the correlation code information corresponding to the personal information and the code information that has been read has been registered with the registration means storing the personal information and the code information of the people. In addition, the photographed face data are converted into the code information, and whether or not the code information mostly agrees with the correlation code information is judged. The authentication information is then output only if the results of the judgment are both affirmative. Therefore, since the authentication by the personal information and the code information as well as the authentication of the face of the holder of the ID card are carried out, security can be improved more.

The face authentication apparatus of the present invention judges whether or not the correlation personal information and the correlation code information corresponding to the personal information and the code information obtained from the face authentication terminal of the present invention has been registered with the registration means storing the personal information and the code information of the people. Meanwhile, the photographed face data obtained by the face authentication terminal are also converted into the code information, and whether or not the code information mostly agrees with the correlation code information is judged. The authentication information is output only in the case where the results of the judgment are both affirmative. Therefore, since the authentication by the personal information and the code information as well as the authentication of the face of the holder of the ID card are carried out, security can be improved more.

By using the predetermined format for the face photo of the ID card, the face photo area represented by the face photo data, and the face image including the face of the holder represented by the photographed face data, accuracy of the judgment can be improved as to whether or not the code information obtained by the code conversion means mostly agrees with the correlation code information.

Particularly, the original images represented by the original image data obtained by photographing the person whose ID card is going to be generated, the face of the holder of the ID card, and the face photo area in the ID card are normalized so that the distance between the center positions of the eyes becomes the predetermined value. In addition, the face photo and the like in the predetermined format are generated by cutting the images in the predetermined format from the normalized original images, with reference to the distance between the center positions of the eyes in the normalized original images. Therefore, the face photo data representing the face photo area and the photographed face data representing the face image can be obtained in the predetermined format, regardless of a photography position of the person. Furthermore, when the face photo area in the ID card is photographed, the face photo data representing the face photo area having the predetermined format can be obtained without accurate positioning of the ID card for photography. Therefore, even in the case where sizes or a position of the faces included in the original images obtained by photography vary from original image to original image due to a change in the photography position of the person or positioning of the ID card at the time of photography of the face photo area of the ID card, the face photo and the like having the predetermined format can be obtained with accuracy. In this manner, positioning of the person or the ID card to be photographed does not need to be accurate.

In addition, the characteristic value or values may be calculated from the respective faces of the original images so that the center positions of the eyes in each of the original images can be recognized based on the characteristic value or values with reference to the reference data. The face sample images used in the learning for obtaining the reference data have the normalized center positions and/or the location relationship of the eyes. Therefore, if a face position in the original image is recognized, the center positions of the eyes in the face correspond to the center positions of the eyes in each of the face sample images. Moreover, if the eyes in any of the original images are not clear due to occlusion by hair or the like, the original images respectively include the characteristic value or values representing the characteristic of the faces. Therefore, the face position and the center positions of the eyes therein can be recognized in the respective original images. As a result, the positions of the eyes in the respective original images can be recognized with accuracy by recognizing the center positions of the eyes in the face in each of the original images with reference to the reference data based on the characteristic value or values calculated from the face images.

Furthermore, by obtaining the reference data in advance through machine learning or the like, recognition performance regarding the center positions of the eyes can be improved more.

### BRIEF DESCRIPTION OF THE DRAWINGS

FIG. 1 is a block diagram showing the configuration of a face authentication system according to an embodiment of the present invention;

FIG. 2 is a top view of an ID card;

FIGS. 3A and 3B show illustrations for explaining an algorithm of face image data generation;

FIG. 4 is an external view of a face authentication terminal;

FIG. 5 is a flow chart showing a procedure carried out in an ID card generation apparatus;

FIG. 6 is a flow chart showing a procedure carried out at the time of authentication;

FIG. 7 is a block diagram showing the configuration of a face authentication terminal of another embodiment of the present invention;

FIG. 8 is the external view of the face authentication terminal whereon an image is displayed;

FIG. 9 is a block diagram showing the configuration of a face extraction apparatus for cutting a face image having a predetermined format from an original image according to an algorithm for cutting an area including a face with reference to center positions of eyes;

FIG. 10 is a block diagram showing the configuration of an eye position detection unit;

FIGS. 11A and 11B are illustrations explaining the center positions of eyes that are looking straight in FIG. 11A but looking to the right in FIG. 11B;

FIGS. 12A and 12B are diagrams respectively showing a horizontal edge detection filter and a vertical edge detection filter;

FIG. 13 is a diagram explaining calculation of gradient vectors;

FIGS. 14A and 14B are illustrations for representing a human face and the gradient vectors around eyes and mouth of the face, respectively;

FIG. 15A is a histogram showing a magnitude of the gradient vector before normalization, FIG. 15B is a histogram showing the magnitude after normalization, FIG. 15C is a histogram of the magnitude represented by 5 values, and FIG. 15D is a histogram showing the magnitude represented by 5 values after normalization;

FIG. 16 shown an example of a face sample image used for learning reference data;

FIG. 17 is a flow chart showing a method of learning the reference data;

FIG. 18 is a diagram showing how a recognizer is generated;

FIG. 19 is a diagram showing a stepwise alteration of the face image;

FIG. 20 is a diagram showing a predetermined format;

FIG. 21 shows how the face image is cut;

FIG. 22 is a flow chart showing a procedure carried out according to the algorithm for cutting the area including the face with reference to the center positions of eyes; and

FIGS. 23A and 23B show examples of the face image.

### DESCRIPTION OF THE PREFERRED EMBODIMENTS

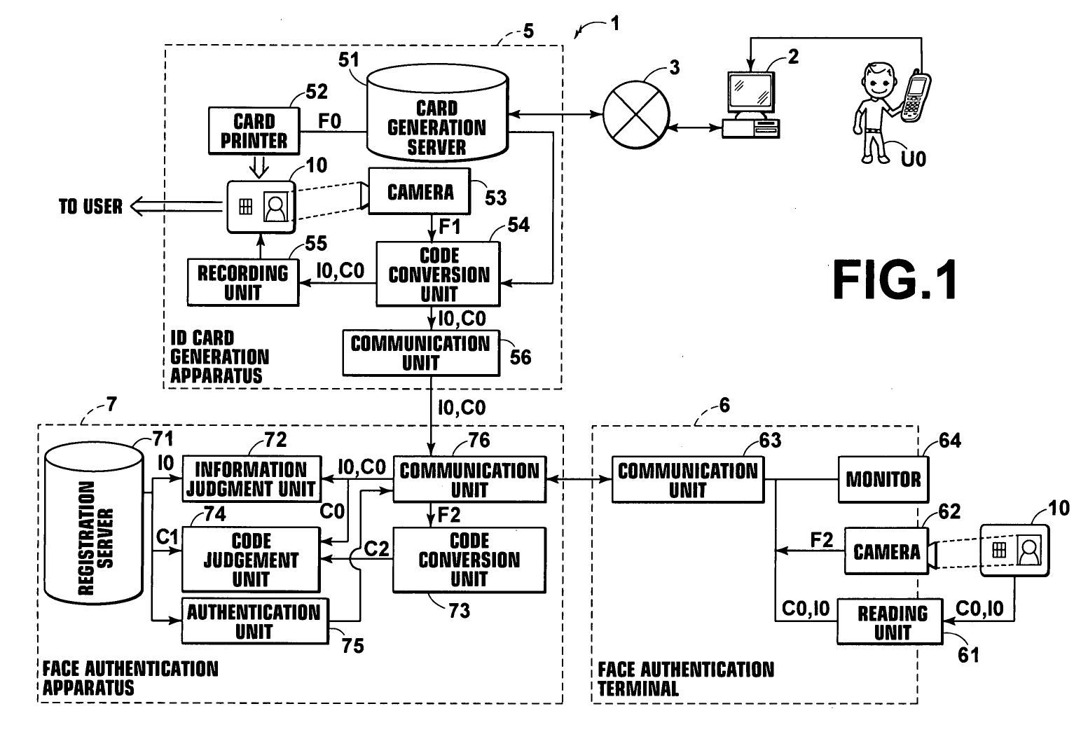

Hereinafter, embodiments of the present invention will be explained with reference to the accompanying drawings. FIG. 1 is a block diagram showing the configuration of a face authentication system according to an embodiment of the present invention. As shown in FIG. 1, a face authentication system 1 in this embodiment comprises an ID card generation apparatus 5 for issuing an ID card 10, a face authentication terminal 6 for photographing a holder of the ID card and for reading information from the ID card, and a face authentication apparatus 7 connected to the face authentication terminal 6 for carrying out face authentication.

The ID card generation apparatus 5 is connected to the Internet 3, and generates the ID card by receiving an order for the ID card via the Internet 3 from a personal computer 2 of a user U0. The ID card generation apparatus 5 comprises a card generation server 51 connected to the Internet 3 for receiving the order, and a card printer 52 for printing a face photo on a blank card added with an IC chip that can store various kinds of information.

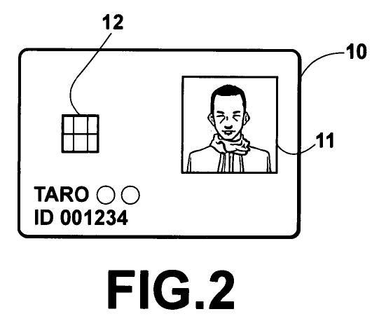

FIG. 2 is a top view showing the configuration of the ID card 10. As shown in FIG. 2, the ID card 10 has a face photo area 11 wherein a face image is printed and an IC chip 12.

The user U0 accesses the card generation server 51 in the card generation apparatus 5 from the personal computer 2, and places the order for the ID card. At this time, the user U0 inputs personal information such as the name, the address, and the phone number of the user U0 and face image data F0 obtained by photographing the face of the user U0 from the personal computer 2 to the ID card generation apparatus 5.

The face image data F0 may be obtained by photographing the user U0 with a digital camera or a mobile phone with built in camera or a camera installed in the personal computer 2. FIG. 1 shows the case of inputting the face image data F0 obtained by photography with a mobile phone with built in camera to the personal computer 2. An algorithm for causing the face photo represented by the face image data F0 to have a predetermined format has been installed in the personal computer 2, or the digital camera, or the mobile phone with built in camera. The face image data F0 representing the face of the user U0 are generated according to the algorithm.

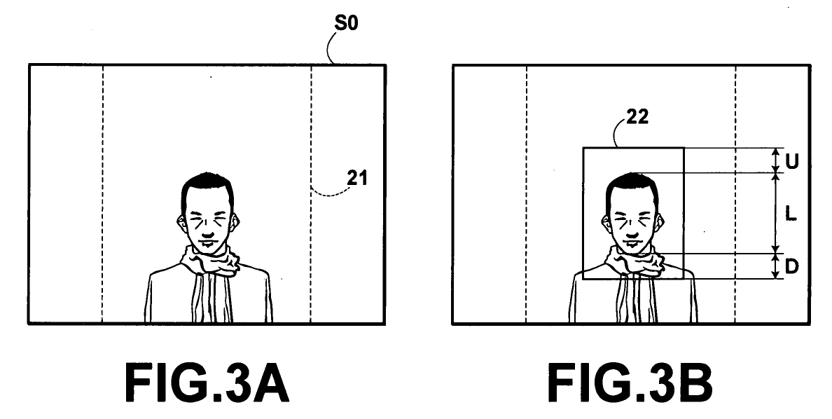

Hereinafter, this algorithm will be explained. A face area is extracted from an original image represented by original image data S0 obtained by the photography (hereinafter, the original image is also referred to as the original image S0). The face area is extracted through extraction of a skin-color area from an area 21 specified in the original image S0 wherein the upper half of the person is represented, as shown in FIG. 3A. When the original image S0 is photographed, it is preferable for the user U0 to carry out the photography by using blue as a background color, for example.

As a method of extracting the skin-color area, whether or not a color tone and a gradation of a pixel fall within predetermined color and gradation ranges representing a face skin color may be judged. If the pixel is judged to have the skin color, each of its neighboring pixels is also subjected to the above-described judgment. By repeating this procedure to expand the skin-color area, the face area can be extracted.

After extraction of the skin-color area, if a skin-color area other than the face is excluded according to a size and a shape of the skin-color area, the face area can be extracted accurately.

After the face area is extracted, a trimming range 22 to be trimmed from the original image S0 is determined with reference to the face area. For example, as shown in FIG. 3B, a predetermined margin U is set from the top of the head while a predetermined margin D is also set from the tip of the chin. The margins U and D are set by multiplying a length L of the face by a predetermined ratio. In this manner, the trimming range can be determined in the vertical direction of the face.

The trimming range is also determined in the horizontal direction of the face, based on an aspect ratio of the face photo area 11 of the ID card 10 and the center of the face. For example, if sizes of the face photo area 11 are 30×20 mm, the aspect ratio is 3:2. Therefore, a length in the horizontal direction can be determined according to a value obtained by multiplying a vertical length (=L+U+D) by ⅔. The horizontal length of the trimming range 22 is then determined in such a manner that lengths from the center of the face to edges of the trimming range 22 are equal in right and left.

The original image S0 is trimmed according to the trimming range 22 determined in the above manner, and the face image data F0 are obtained.

As the algorithm for causing the face photo to have the predetermined format, a method of determining a trimming range (see Japanese Unexamined Patent Publication No. 2002-152492) may also be used. In this method, positions of the top of the head and the eyes are detected in a face included in an original image, and the trimming range is determined by inferring a position of the tip of the chin. Alternatively, a method of trimming by detecting the top of the head and the tip of the chin included in an original image (see Japanese Unexamined Patent Publication No. 2001-311996) may also be used.

The ID card generation apparatus 5 further comprises a camera 53 for photographing the face photo area 11 of the ID card 10 and for obtaining face photo data F1 representing the face photo in the predetermined format according to the same algorithm as in the case of obtaining the face image data F0, a code conversion unit 54 for converting the face photo data F1 into code information C0, a recording unit 55 for storing personal information I0 sent from the user U0 and the code information C0 in the IC chip 12, and a communication unit 56 for sending the personal information I0 and the code information C0 to the face authentication apparatus 7.

The code conversion unit 54 converts the face photo data F1 into vectors (eigenvectors) specific to the face photo represented by the face photo data F1 by carrying out principal component analysis on the face photo data F1. The eigenvectors are the code information C0.

The code information C0 is not necessarily limited to the eigenvectors. For example, characteristic values representing locations of facial features such as eyes, nose, and mouth in the face photo represented by the face photo data F1, or eigenvectors of the facial features obtained by principal component analysis thereof may be used as the code information C0. Alternatively, areas having density contrast such as sides of eyes and nose, mouth, eyebrows, and cheeks may be extracted as face characteristic values by using a neural network so that values obtained by quantification and normalization of the face characteristic values can be used as the code information C0.

The recording unit 55 stores the personal information I0 in the IC chip 12. The personal information may have a membership number or the like, which cannot be designated by the user U0.

The ID card 10 having the face photo area 11 printed thereon and the IC chip 12 storing the personal information I0 and the code information C0 is provided to the user U0. At this time, the ID card 10 is provided to the user U0 after the user U0 is confirmed to be the person represented by the ID card 10 through comparison of the face photo area 11 in the ID card and the face of the user U0.

The face authentication terminal 6 comprises a reading unit 61, a camera 62, a communication unit 63, and a monitor 64. The reading unit 61 carries out non-contact reading of the personal information I0 and the code information C0 from the IC chip 12 of the ID card 10 held by a person subjected to authentication. The camera 62 photographs the face of the person as the holder, and obtains photographed face data F2 representing a face image including the face of the person in the predetermined format by the same algorithm as in the case of obtaining the face image data F0. The communication unit 63 sends the personal information I0, the code information C0, and the photographed face data F2 to the face authentication apparatus 7. The monitor 64 displays various kinds of information including the photographed face data F2.

The reading unit 61 carries out non-contact reading of the personal information I0 and the code information C0 stored in the IC chip 12, by using a known method such as electromagnetic induction.

The camera 62 trims the image obtained by the photography, according to the same algorithm as the algorithm for generating the face image data F0. In this manner, the camera 62 obtains the photographed face data F2 representing the face image including the face of the person subjected to authentication.

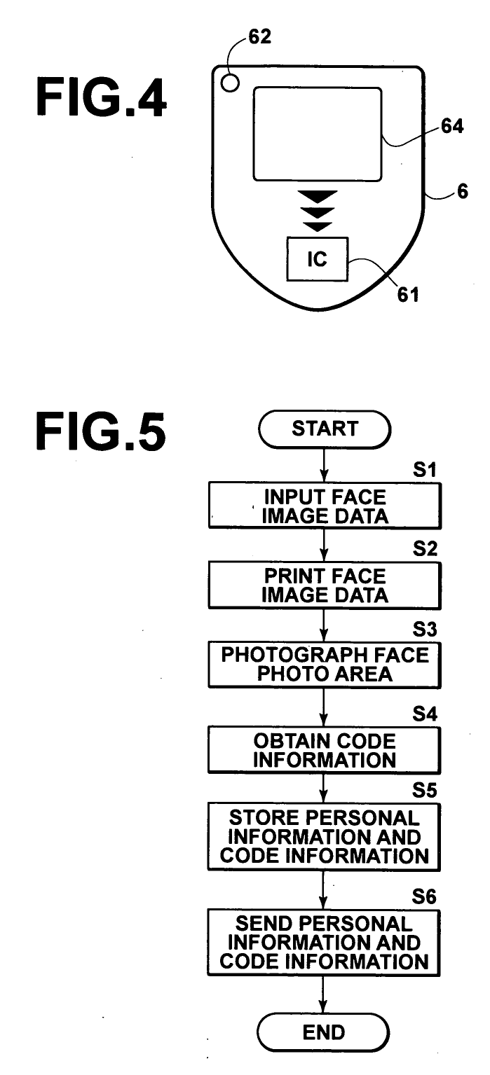

FIG. 4 is an external view of the face authentication terminal 6. As shown in FIG. 4, the reading unit 61 is added with letters “IC”. By holding the IC chip 12 close to the reading unit 61, the personal information I0 and the code information C0 is read from the IC chip 12 of the ID card 10. The camera 62 is placed in the upper left corner of the face authentication terminal 6.

The face authentication apparatus 7 comprises a registration server 71, an information judgment unit 72, a code conversion unit 73, a code judgment unit 74, an authentication unit 75, and a communication unit 76. The registration server 71 stores personal information I0 and code information C0 of a large number of people. The information judgment unit 72 judges whether or not correlation personal information I1 and correlation code information C1 corresponding to the personal information I0 and the code information C0 sent from the face authentication terminal 6 has been registered with the registration server 71. The code conversion unit 73 converts the photographed face data F2 into code information C2 in the same manner as the code conversion unit 54 of the ID card generation apparatus 5. The code judgment unit 74 judges whether or not the code information C2 agrees with the correlation code information C1. The authentication unit 75 generates authentication information representing the fact that the person subjected to authentication by the face authentication terminal 6 has been authenticated in the case where results of the judgment by the information judgment unit 72 and the code judgment unit 74 are both affirmative. The communication unit 76 sends and receives various kinds of information to and from the ID card generation apparatus 5 and the face authentication terminal 6.

The code judgment unit 74 judges whether or not the code information C2, that is, eigenvectors V2 of the photographed face data F2, agree with eigenvectors V1 corresponding to the correlation code information C1. More specifically, the judgment is carried out as to whether or not directions and magnitudes of the eigenvectors V2 are within ±10% of those of the eigenvectors V1. If a result of the judgment is affirmative, the code information C2 is judged to agree with the correlation code information C1. Instead of the correlation code information C1, the code information C0 may be judged regarding agreement with the code information C2.

A procedure carried out in this embodiment will be explained next. FIG. 5 is a flow chart showing a procedure carried out in the ID card generation apparatus 5. The user U0 has placed the order for the ID card 10 by using the personal computer 2, and the personal information I0 and the code information C0 of the user U0 has already been stored in the card generation server 51.

The card generation server 51 inputs the face image data F0 to the card printer 52 (Step S1). The card printer 52 prints the face image data F0 on the blank card used for the ID card 10 (Step S2). The camera 53 photographs the face photo area 11 of the ID card 10, and obtains the face photo data F1 (Step S3). The camera 53 may be moved forward automatically or manually by an operator of the ID card generation apparatus 5.

The code conversion unit 54 converts the face photo data F1, and obtains the code information C0 (Step S4). The recording unit 55 stores the personal information I0 and the code information C0 in the IC chip 12 (Step S5). The communication unit 56 sends the personal information I0 and the code information C0 to the face authentication apparatus 7 (Step S6). In this manner, the ID card 10 is generated and provided to the user U0.

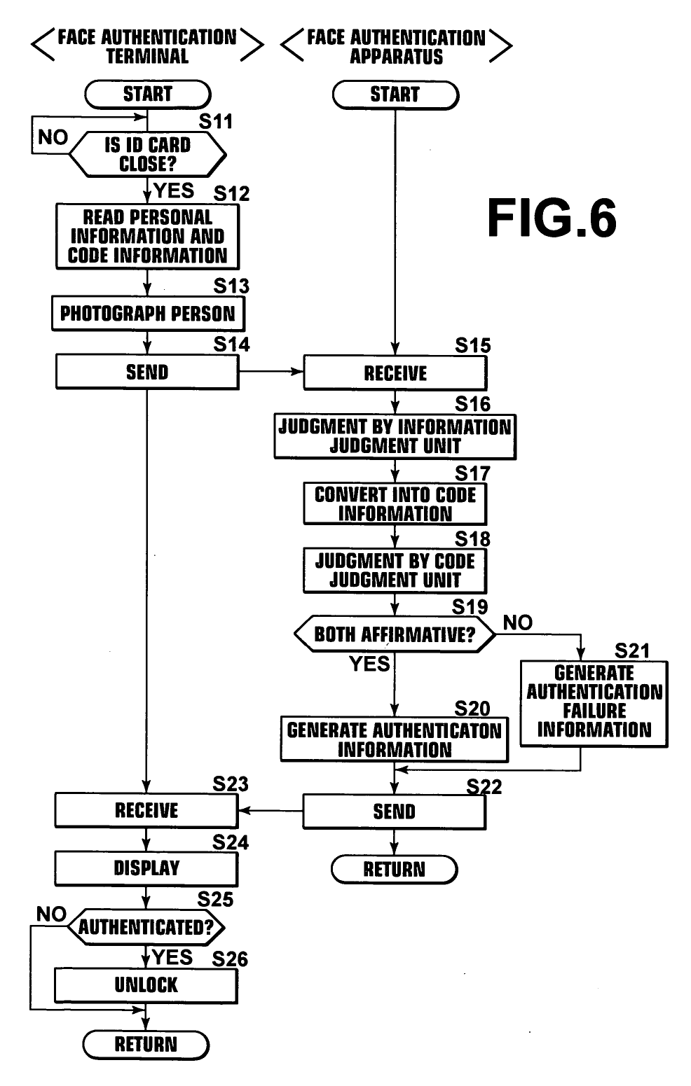

FIG. 6 is a flow chart showing a procedure carried out at the time of authentication. The case where authentication is carried out for opening a door to a security area will be explained below.

The reading unit 61 is continuously monitoring whether or not the ID card 10 is held close to the reading unit 61 (Step S11). When the person subjected to authentication as the holder of the ID card 10 stands in front of the face authentication terminal 6 and holds the ID card 10 close to the reading unit 61, a result of the judgment at Step S11 becomes affirmative. The reading unit 61 then reads the personal information I0 and the code information C0 from the IC chip 12 of the ID card 10 (Step S12). At the same time, the camera 62 photographs the face of the person subjected to authentication, and obtains the photographed face data F2 (Step S13). At this time, the person may be notified of the photography by voice or the like. The photographed face data F2 may be displayed on the monitor 64. The communication unit 63 sends the personal information I0, the code information C0, and the photographed face data F2 to the face authentication apparatus 7 (Step S14).

The face authentication apparatus 7 receives the personal information I0, the code information C0, and the photographed face data F2 (Step S15). The information judgment unit 72 judges whether or not the correlation personal information I1 and the correlation code information C1 corresponding to the personal information I0 and the code information C0 that has been received has been registered with the registration server 71 (Step S16). The code conversion unit 73 converts the photographed face data F2 into the code information C2 (Step S17), and the code judgment unit 74 judges whether or not the code information C2 agrees with the correlation code information C1 (Step S18).

The authentication unit 75 judges whether or not the results of the judgment by the information judgment unit 72 and the code judgment unit 74 are both affirmative (Step S19). If a result at Step S19 is affirmative, the authentication unit 75 generates the authentication information representing the fact that the person has been authenticated (Step S20). If the result at Step S19 is negative, the authentication unit 75 generates authentication failure information representing the fact that the person has not been authenticated (Step S21). The communication unit 76 sends the authentication information or the authentication failure information to the face authentication terminal 6 (Step S22).

The communication unit 63 of the face authentication terminal 6 receives the authentication information or the authentication failure information (Step S23), and displays the fact that the person has been authenticated or not authenticated on the monitor 64 (Step S24). Instead of the display, voice may be used for notifying the fact. Whether or not the person has been authenticated is then judged (Step S25). If a result at Step S25 is affirmative, the door is opened (Step S26) to end the procedure. If the result at Step S25 is negative, the procedure ends.

As has been described above, according to this embodiment, the face photo data F1 are obtained by photography of the face photo area 11 of the ID card 10. The code information C0 obtained by conversion of the face photo data F1 is stored in the IC chip 12 and registered with the registration server 71 of the face authentication apparatus 7. Therefore, even if the face photo area 11 is forged or code information obtained from face photo data of a forger is stored in the IC chip 12, the code information in the IC chip 12 does not agree with the code information registered with the registration server 71 of the face authentication apparatus 7. Therefore, the forger is not authenticated. Even if the face photo area 11 of the ID card 10 is replaced to forge the ID card 10, the code information obtained by photographing the face photo area 11 of the ID card 10 does not completely agree with the code information C0 stored in the IC chip 12 or the code information registered with the registration server 71 even if the forger is the holder himself/herself. Therefore, forgery of the ID card 10 can be easily found. Therefore, according to this embodiment, the ID card 10 that is not easy to forge can be generated.

Furthermore, the face authentication apparatus 7 in this embodiment carries out authentication by the personal information I0 and the code information C0, as well as authentication of the person through photography of the face of the person. Therefore, security can be improved more.

By using the predetermined format for the image represented by the face image data F0, the image represented by the face photo data F1 obtained by photographing the face photo area 11, and the face image represented by the photographed face data F2 that represents the person subjected to authentication, accuracy of the judgment can be improved as to whether or not the code information C2 converted by the code conversion unit 73 mostly agrees with the correlation code information C1.

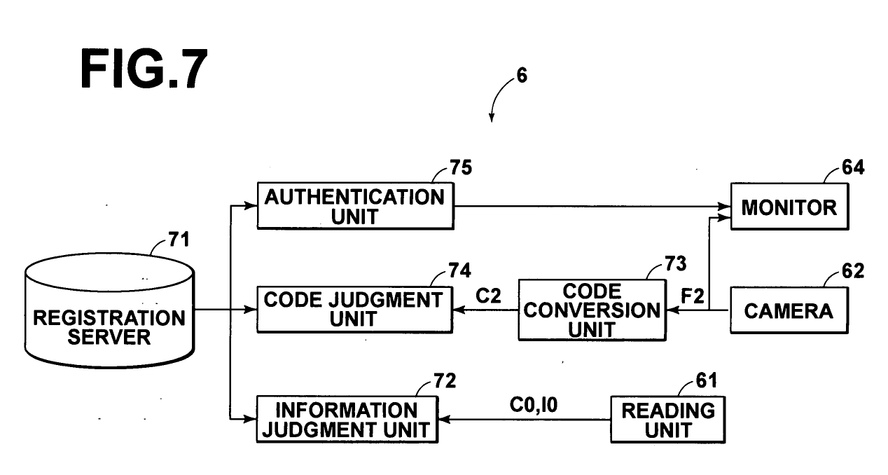

In the above embodiment, the face authentication terminal 6 is placed separately from the face authentication apparatus 7. However, as shown in FIG. 7, the face authentication terminal 6 may comprise the registration server 71, the information judgment unit 72, the code conversion unit 73, the code judgment unit 74, and the authentication unit 75 so that the face authentication terminal 6 can solely carry out authentication.

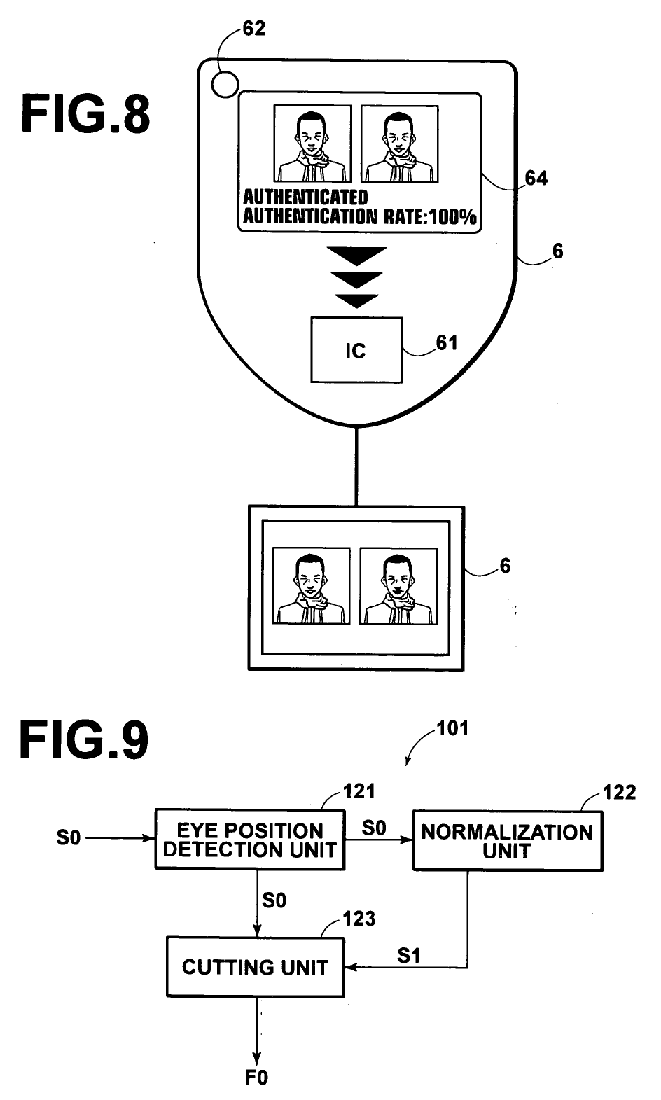

In the above embodiment, the face image data from which the correlation code information C1 has been generated may be reproduced from the correlation code information C1 and displayed on the monitor 64 of the face authentication terminal 6 together with the photographed face data F2, as shown in FIG. 8. In addition, a degree of agreement judged by the code judgment unit 74 between the directions and the magnitudes of the eigenvectors V1 and V2 may be displayed as an authentication rate. In this case, the face image data that have been reproduced cannot completely reproduce the original face image data. However, since comparison can be made to some degree, authentication by visual inspection using the face authentication terminal 6 can be carried out. In this manner, security of the face authentication system 1 can be improved further. In this case, the face authentication terminal 6 may be connected to a monitor 9 of a security room so that authentication by visual inspection can be carried out in the security room.

In the above embodiment, the case has been explained where the ID card is used for authentication to open the door to the security area. However, the ID card in this embodiment may be applied to a credit card for authentication of a person upon use of the credit card. A conventional credit card allows a third person to use the card if the card is stolen. However, if a credit card is added with the IC chip 12 for storing the code information C0 as the ID card 10 of this embodiment, and the face of the person as a user of the credit card is photographed in the same manner as this embodiment, whether or not the user is the person can be authenticated securely. Therefore, the credit card can be prevented from being used after being stolen.

The ID card in this embodiment can be applied to confirm a patient before an operation in a hospital. Conventionally, information necessary for an operation such as the name and an X ray image of the patient is managed by a number as a code tag or the like, which may lead to mix-up of patients if the information is not managed prudently. Therefore, if the IC chip 12 is added to an ID card used for patient confirmation and stores the code information C0 in relation to the information necessary for the operation, and if the face of the patient subjected to the operation is also photographed for judgment in the same manner as the embodiment described above, the patient can be authenticated securely, and mix-up of patients can be prevented.

In the above embodiment, the IC chip 12 is added to the ID card 10 and stores the personal information I0 and the code information C0. However, instead of the IC chip 12, a magnetic strip may be used for the ID card 10 for storing the personal information I0 and the code information C0.

In the algorithm in the above embodiment for causing the images represented by the face image data F0, the face photo data F1, and the photographed face data F2 to have the predetermined format, the skin-color area is extracted from the original images, and the range to be trimmed is determined with reference to the skin-color area, as shown in FIGS. 3A and 3B. However, an algorithm may be applied for cutting an area including face with reference to center positions of eyes. Hereinafter, this algorithm will be explained. In the explanations below, the case will be explained where the image represented by the face image data F0 (hereinafter, this image is called the face image, and the same reference number F0 is used therefor) is cut from the original image S0.

FIG. 9 is a block diagram showing the configuration of a face extraction apparatus for cutting the face image F0 having a predetermined format from the original image S0 according to the algorithm with reference to the center positions of eyes.

As shown in FIG. 9, a face extraction apparatus 101 comprises an eye position detection unit 121, a normalization unit 122, and a cutting unit 123. The eye position detection unit 121 detects the center positions of eyes included in the face of the original image S0. The normalization unit 122 obtains a normalized original image S1 by normalizing the original image S0 so as to cause the distance between the center positions of eyes to become a predetermined value. The cutting unit 123 cuts the face image F0 having the predetermined format from the original image S0 with reference to the distance between the center positions of eyes in the normalized original image S1.

The images represented by the face photo data F1 and the photographed face data F2 can have the predetermined format if the cameras 53 and 64 have the eye position detection unit 121, the normalization unit 122, and the cutting unit 123, as the face extraction apparatus 101 does.

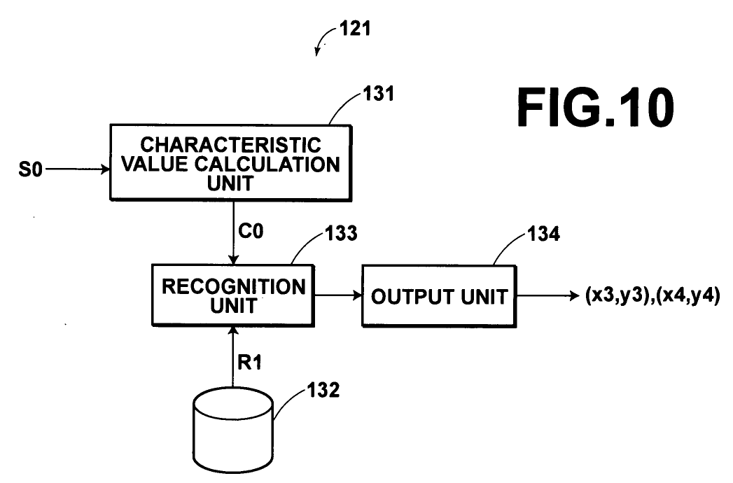

FIG. 10 is a block diagram showing the configuration of the eye position detection unit 121. As shown in FIG. 10, the eye position detection unit 121 comprises a characteristic value calculation unit 131, a memory 132, a recognition unit 133, and an output unit 134. The characteristic value calculation unit 131 calculates characteristic values C0 from the original image S0. The memory 132 stores reference data R1 that will be explained later. The recognition unit 133 recognizes the center positions of eyes of the face included in the original image S0, based on the characteristic values C0 found by the characteristic value calculation unit 131 and the reference data R1 stored in the memory 132. The output unit 134 outputs a result of recognition by the recognition unit 133.

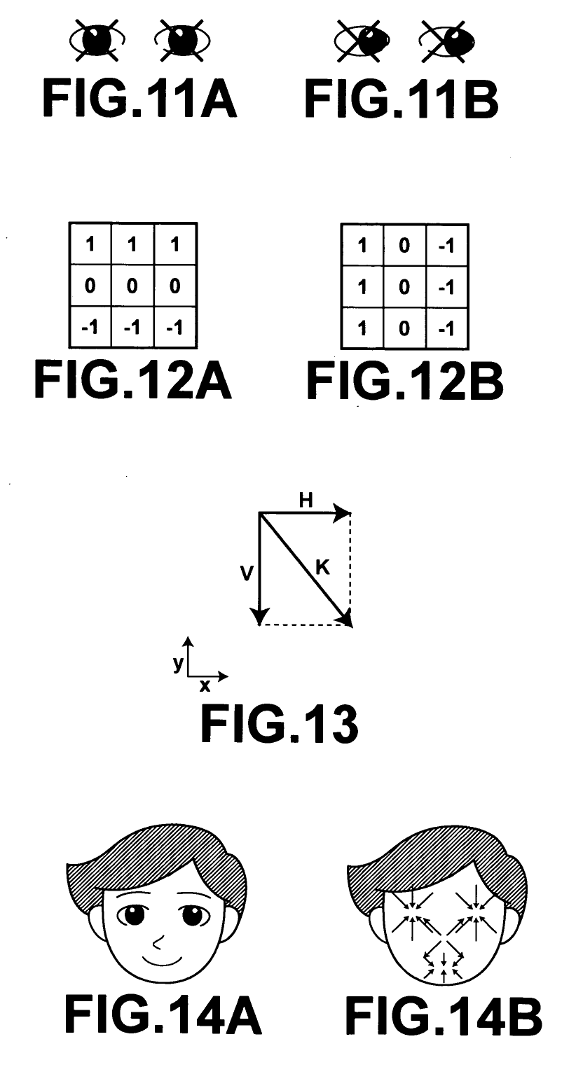

In this embodiment, each of the center positions of eyes refers to the center position between corner tail and inner corner of eye. As shown in FIG. 11A, in the case of eyes looking straight, the center positions refer to positions of pupils (shown by X in FIGS. 11A and 11B). In the case that eyes are looking to the right as shown in FIG. 11B, the center positions fall not on the pupils but on the whites of the eyes.

The characteristic value calculation unit 131 calculates the characteristic values C0 for recognition of the center positions of eyes from the original image S0. More specifically, gradient vectors (that is, directions and magnitudes of changes in density in pixels in the original image S0) are calculated as the characteristic values C0. Hereinafter, how the gradient vectors are calculated will be explained. The characteristic value calculation unit 131 carries out filtering processing on the original image S0 by using a horizontal edge detection filter shown in FIG. 12A. In this manner, an edge in the horizontal direction is detected in the original image S0. The characteristic value calculation unit 131 also carries out filtering processing on the original image S0 by using a vertical edge detection filter shown in FIG. 12B. In this manner, an edge in the vertical direction is detected in the original image S0. The characteristic value calculation unit 131 then calculates a gradient vector K at each pixel as shown in FIG. 13, based on magnitudes of a horizontal edge H and a vertical edge V thereat. The characteristic value calculation unit 131 calculates the characteristic values C0 at each step of alteration of the original image S0 as will be explained later.

As shown in FIG. 14B, the gradient vectors K calculated in this manner point to the centers of eyes and mouth in dark areas such as eyes and mouth if the face shown in FIG. 14A is used for the calculation. In a light area such as nose, the gradient vectors K point outward from the nose. Since the density changes are larger in the eyes than in the mouth, the magnitudes of the gradient vectors K are larger in the eyes than in the mouth.

The directions and the magnitudes of the gradient vectors K are used as the characteristic values C0. The directions of the gradient vectors K are represented by values ranging from 0 to 359 degrees from a predetermined direction (such as the direction x shown in FIG. 13).

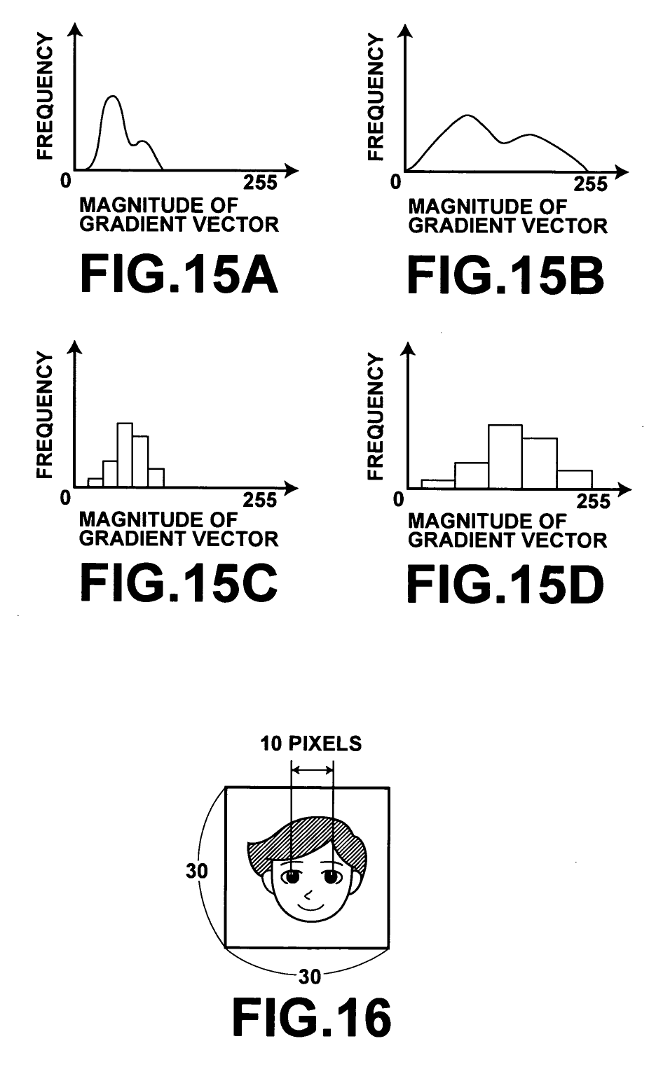

The magnitudes of the gradient vector K are normalized. For normalization thereof, a histogram of the magnitudes of the gradient vectors K at all the pixels in the original image S0 is generated, and the magnitudes are corrected by smoothing the histogram in such a manner that distribution of the magnitudes spreads over entire values (such as 0˜255 in the case of 8-bit data) that the pixels in the original image S0 can take. For example, if the magnitudes of the gradient vectors K are small and the values in the histogram are thus spread mainly in smaller values as shown in FIG. 15A, the magnitudes are normalized so that the magnitudes can spread over the entire values ranging from 0 to 255, as shown in FIG. 15B. In order to reduce an amount of calculations, a range of value distribution in the histogram is preferably divided into 5 ranges as shown in FIG. 15C so that normalization can be carried out in such a manner that the distribution in the 5 ranges spreads over ranges obtained by dividing the values 0˜255 into 5 ranges.

The reference data R1 stored in the memory 132 define a recognition condition for a combination of the characteristic values C0 at each of pixels in each of pixel groups of various kinds comprising a combination of pixels selected from sample images that will be explained later.

The recognition condition and the combination of the characteristic values C0 at each of the pixels comprising each of the pixel groups are predetermined through learning of sample image groups including face sample images and non-face sample images.

In this embodiment, when the reference data R1 are generated, sizes of the face sample images are 30×30 pixels and the distance between the center positions of eyes is 10 pixels, as shown in FIG. 16. In all the face sample images, the center positions of eyes are the same. The center positions are represented by coordinates (x1, y1) and (x2, y2) whose origin is the upper left corner of the face sample images. The center positions of eyes in the face sample images used for learning the reference data R1 are the center positions of eyes to be recognized.

As the non-face sample images, any images having the same sizes (30×30 pixels) are used.

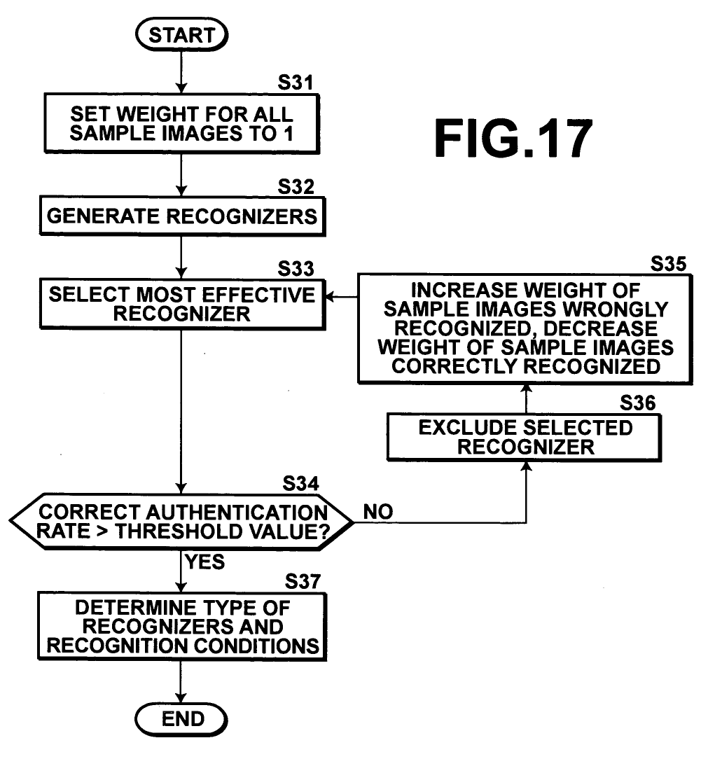

Hereinafter, the learning of the sample image groups will be explained with reference to the flow chart in FIG. 17.

The sample image groups comprise the face sample images and the non-face sample images. A weight, that is, importance, is assigned to each of the sample images. The weight is set to 1 at first for all the sample images (Step S31).

A recognizer is generated for each of the pixel groups of the various kinds in the sample images (Step S32). The recognizer provides a criterion for recognizing whether each of the sample images represents a face image or a non-face image, by using the combination of the characteristic values C0 at each of the pixels in each of the pixel groups. In this embodiment, a histogram of the combinations of the characteristic values C0 at the respective pixels corresponding to each of the pixel groups is used as the recognizer.

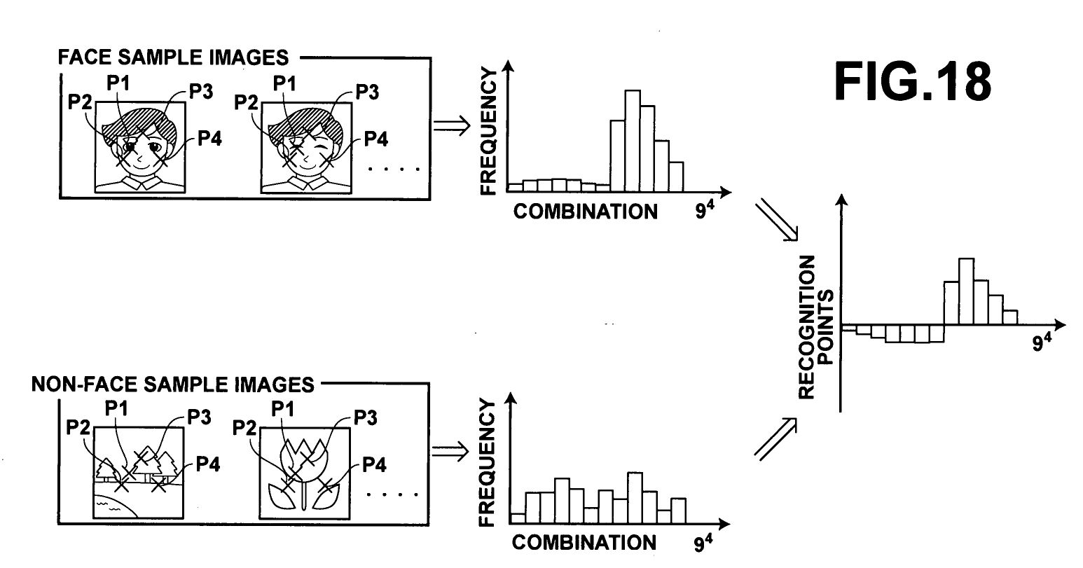

How the recognizer is generated will be explained with reference to FIG. 18. As shown by the sample images in the left of FIG. 18, the pixels comprising each of the pixel groups for generating the recognizer include a pixel P1 at the center of the right eye, a pixel P2 in the right cheek, a pixel P3 in the forehead, and a pixel P4 in the left cheek in the face sample images. The combination of the characteristic values C0 is found at each of the pixels P1˜P4 in the face sample images, and the histogram is generated. The characteristic values C0 represent the direction and the magnitude of the gradient vector K thereat. Therefore, since the direction ranges from 0 to 359 and the magnitude ranges from 0 to 255, the number of the combinations can be 360×256 for each of the pixels if the values are used as they are. The number of the combinations can then be (360×256)⁴ for the four pixels P1 to P4. As a result, the number of samples, memory, and time necessary for the learning and detection would be too large if the values were used as they are. For this reason, in this embodiment, the directions are represented by 4 values ranging from 0 to 3. If the original value of the direction is from 0 to 44 and from 315 to 359, the direction is represented by the value 0 that represents a rightward direction. Likewise, the original direction value ranging from 45 to 134 is represented by the value 1 that represents an upward direction. The original direction value ranging from 135 to 224 is represented by the value 2 that represents a leftward direction, and the original direction value ranging from 225 to 314 is represented by the value 3 that represents a downward direction. The magnitudes are also represented by 3 values ranging from 0 to 2. A combination value is then calculated according to the equation below:
value of combination=0 (if the magnitude is 0)
value of combination=(the direction value+1)×the magnitude value (if the magnitude value>0)

In this manner, the number of combinations becomes 9⁴, which can reduce the number of data of the characteristic values C0.

Likewise, the histogram is generated for the non-face sample images. For the non-face sample images, pixels corresponding to the positions of the pixels P1 to P4 in the face sample images are used. A histogram of logarithms of a ratio of frequencies in the two histograms is generated as shown in the right of FIG. 18, and is used as the recognizer. Values of the vertical axis of the histogram used as the recognizer are referred to as recognition points. According to the recognizer, the larger the absolute values of the recognition points that are positive, the higher likelihood becomes that an image showing a distribution of the characteristic values C0 corresponding to the positive recognition points represents a face. On the contrary, the larger the absolute values of the recognition points that are negative, the higher likelihood becomes that an image showing a distribution of the characteristic values C0 corresponding to the negative recognition points does not represent a face. At Step S32, the recognizers are generated in the form of the histograms for the combinations of the characteristic values C0 at the respective pixels in the pixel groups of various kinds that can be used for recognition.

One of the recognizers generated at Step S32 that can be used most effectively for recognizing a face or a non-face is selected. This selection of the most effective recognizer is made in consideration of the weight of each of the sample images. In this example, a weighted correct authentication rate is compared among the recognizers, and the recognizer having the highest weighted correct authentication rate is selected (Step S33). More specifically, the weight for each of the sample images is 1 at Step S33 when the procedure at Step S33 is carried out for the first time. Therefore, the recognizer, by which the number of the sample images recognized as the face or non-face images becomes the largest, is selected as the most effective recognizer. In the procedure at Step S33, carried out for the second time or later after Step S35, whereat the weight is updated for each of the sample images as will be explained later, the sample images have the various weights such as 1, larger than 1, or smaller than 1. The sample images whose weight is larger than 1 contributes more than the sample images whose weight is smaller than 1, when the correct authentication rate is evaluated. In this manner, in the procedure at Step S33 after Step S35, right recognition of the sample images whose weight is larger is more emphasized.

Judgment is made as to whether the correct authentication rate of a combination of the recognizers that have been selected exceeds a predetermined threshold value (Step S34). In other words, a rate representing how correctly each of the sample images is recognized as the face image or non-face image by using the combination of the recognizers that have been selected is examined. For this evaluation of the correct authentication rate, the sample images having the current weight or the sample images having the same weight may be used. In the case where the correct authentication rate exceeds the predetermined threshold value, recognition of face image or non-face image can be carried out at a probability that is high enough, by using the recognizers that have been selected. Therefore, the learning ends. If the result is equal to or smaller than the threshold value, the procedure goes to Step S36 for further selecting another one of the recognizers to be combined with the recognizers that have been selected.

At Step S36, the recognizer that has been selected immediately at Step S33 is excluded for not selecting the same recognizer.

The weight of the sample images which have not been recognized correctly as the face images or non-face images by the recognizer selected immediately at Step S33 are weighted more while the sample images whose recognition was correct at Step S33 are weighted less (Step S35). This procedure is carried out because the sample images whose recognition was not correctly carried out by the recognizers that have been selected are used more importantly than the correctly recognized sample images in the selection of the additional recognizer. In this manner, the recognizer that can carry out correct recognition on the heavily weighted sample images is selected in order to improve effectiveness of the combination of the recognizers.

The procedure then goes back to Step S33, and the effective recognizer is selected based on the weighted correct authentication rate, as has been described above.

If the correct authentication rate exceeds the predetermined threshold value at Step S34 when the recognizers corresponding to the combinations of the characteristic values at the respective pixels in a specific one of the pixel groups is selected as the recognizers that are appropriate for recognizing the presence or absence of a face by repeating the procedure from Step S33 to Step S36, the type of the recognizers and the recognition conditions used for recognition of presence or absence of face are confirmed (Step S37) to end the learning of the reference data R1.

If the learning method described above is used, the recognizers can be any recognizers other than the histograms described above, as long as the recognizers can provide a criterion for distinction of face images and non-face images by using the combinations of the characteristic values C0 at the respective pixels comprising a specific one of the pixel groups. For example, the recognizers can be binary data, or threshold values, or functions. In the case of histogram, a histogram representing distribution of differences between the histograms shown in the middle of FIG. 18 may also be used.

The method of learning is not necessarily limited to the method described above. A machine learning method such as that which employs a neural network may also be adopted.

The recognizer 133 finds the recognition points in the original image S0 for all the combinations of the characteristic values C0 at the respective pixels comprising each of the pixel groups, with reference to the recognition conditions learned by the reference data R1 regarding all the combinations of the characteristic values C0 at the respective pixels comprising the pixel groups. The center positions of eyes in the face are recognized by addition of all the recognition points. At this time, the directions and the magnitudes of the gradient vectors K as the characteristic values C0 are represented by the 4 values and the 3 values, respectively.

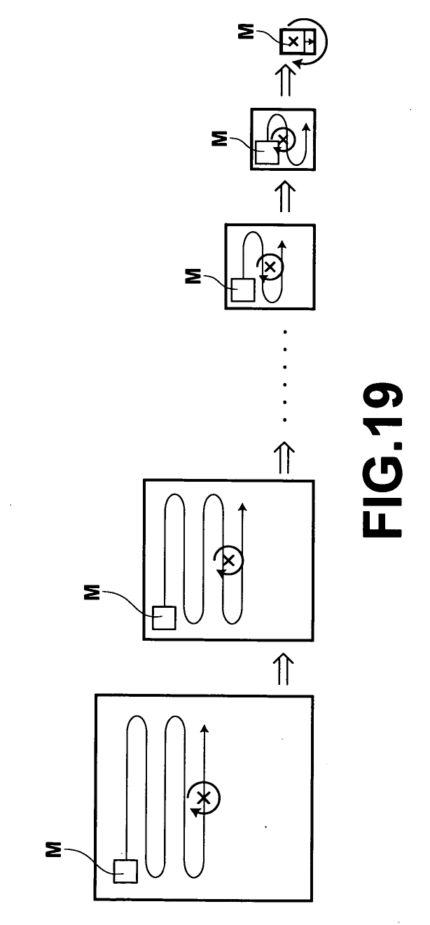

The face in the original image S0 may have a different size from the faces in the sample images of 30×30 pixels. Furthermore, an angle of rotation of the face in two dimensions may not necessarily be 0. For this reason, the recognizer 133 enlarges or reduces the original image S0 in a stepwise manner as shown in FIG. 19 (showing the case of reduction), for causing the vertical or horizontal size of the original image S0 to become 30 pixels (or smaller if necessary) while rotating the original image S0 by 360 degrees in a stepwise manner. A mask M whose sizes are 30×30 pixels is set in the original image S0 enlarged or reduced at each of the steps, and the mask M is shifted by one pixel in the enlarged or reduced original image S0 for recognition of the center positions in the mask.

The characteristic value calculation unit 133 calculates the characteristic values C0 at each of the steps of the alteration caused by the enlargement or reduction and the rotation.

In this embodiment, the recognition points at all the steps of alteration of the extracted face image are added, and a face of the sizes corresponding to the sample images is judged to exist within the mask M whose sizes are 30×30 pixels at the step of alteration generating the largest recognition points to be added. Therefore, coordinates whose origin is at the upper left corner are set in the image in the mask M, and positions corresponding to the center positions of eyes (x1, y1) and (x2, y2) in the sample images are found. The positions corresponding to the coordinates are judged to be the center positions of eyes in the original image S0 before alteration. The center positions are represented by (x3, y3) and (x4, y4) for the right and left eyes in the face image in the original image S0. In this case, y3=y4.

The output unit 134 outputs the coordinates (x3, y3) and (x4, y4) representing the center positions of eyes recognized by the recognition unit 133.

The normalization unit 122 calculates a distance D0 between the center positions of eyes detected in the original image S0 by the eye position detection unit 121, based on the coordinates (x3, y3) and (x4, y4) thereof. The normalization unit 122 obtains the normalized original image S1 by normalizing the original image S0 through enlargement or reduction thereof so that the distance D0 becomes a predetermined distance D1. Since y3=y4, the number of pixels between the center positions of eyes in the original image S0 is represented by (x4-x3). The predetermined distance D1 is set to the number of pixels that can generate an input authentication image S2 of a predetermined size that will be explained later. In the normalized original image S1, the distance between the center positions of eyes is D1. The center positions of eyes in the normalized original image S1 can be calculated according to a magnification rate used at the time of the enlargement or reduction, and are represented by coordinates (x5, y5) and (x6, y6) for right and left eyes in the normalized original image S1, respectively. Since y5=y6, the number of pixels between the center positions of eyes in the normalized original image S1 is represented by (x5-x6).

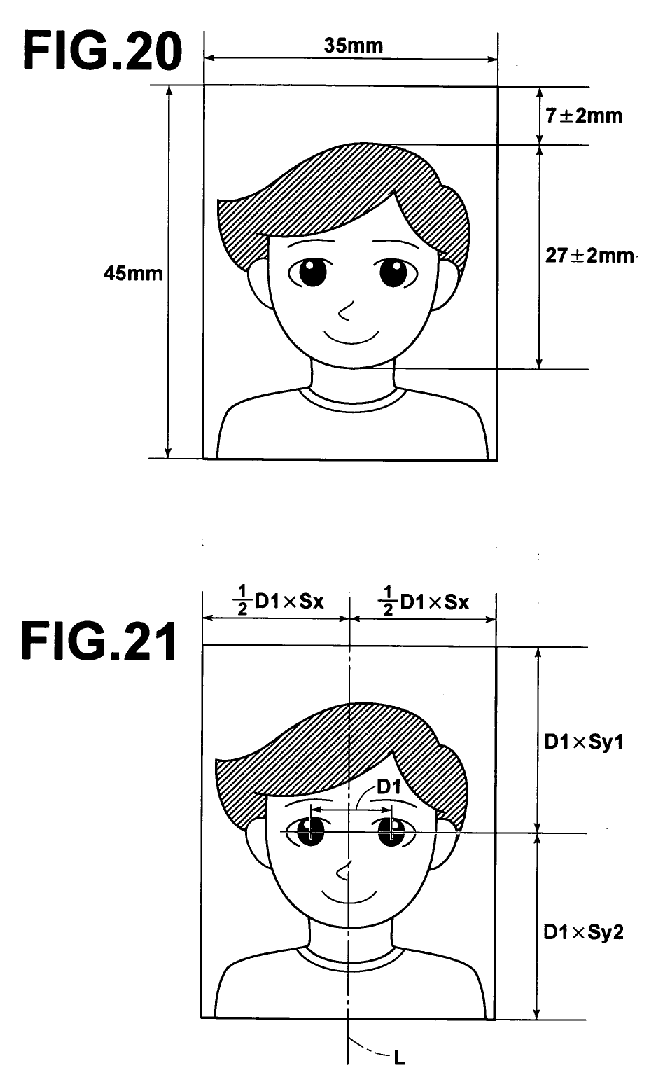

The cutting unit 123 cuts the face image F0 from the normalized original image S1 in such a manner that the face image F0 has the predetermined format upon printing by a printer having a predetermined resolution or upon display on a monitor of a predetermined resolution. As shown in FIG. 20, in the predetermined format, the length of the face (that is, the distance between the top of the head and the tip of the chin) is 27±2 mm, and a distance from the top of the head to the upper side of a trimming frame is 7±2 mm. A horizontal length is 35 mm while a vertical length is 45 mm. More specifically, the face image F0 is cut out from the normalized original image S1 in the following manner. FIG. 21 is a diagram showing how the face image F0 is cut. As shown in FIG. 21, the cutting unit 123 sets a perpendicular bisector L of the distance D1 between the center positions of eyes in the normalized original image S1. At this time, the cutting unit 123 has a parameter Sx for determining positions of the left and right sides of the trimming frame. Therefore, the cutting unit 123 determines the positions of the left and right sides of the trimming frame at positions where distances from the perpendicular bisector L thereto are represented by ½D1×Sx.

The cutting unit 123 also has parameters Sy1 and Sy2 for determining positions of the upper and lower sides of the trimming frame. The cutting unit 123 therefore sets the upper side of the trimming frame on the position where a distance thereto from the y coordinates y5 and y6 is D1×Sy1, and sets the lower side thereof to the position where a distance thereto from the y coordinates y5 and y6 is D1×Sy2.

The parameter Sx is determined so as to minimize an error between D1×Sx and D10+D11 where D10 and D11 respectively represent distances from the perpendicular bisector L to the left and right sides of sample images having a size that can generate the image having the predetermined format shown in FIG. 20 upon printing thereof while the distance between the center positions of eyes is normalized to D1.

The parameter Sy1 is determined so as to minimize an error between D1×Sy1 and D12 where D12 represents a distance from the y coordinate of the center positions of eyes to the upper side of sample images having a size that can generate the image having the predetermined format shown in FIG. 20 upon printing thereof while the distance between the center positions of eyes is normalized to D1.

The parameter Sy2 is determined so as to minimize an error between D1×Sy2 and D13 where D13 represents a distance from the y coordinate of the center positions of eyes to the lower side of sample images having a size that can generate the image having the predetermined format shown in FIG. 20 upon printing thereof while the distance between the center positions of eyes is normalized to D1.

More specifically, the parameters Sx, Sy1 and Sy2 whose ratio Sx:Sy1:Sy2=5.04:3.01:3.47 are used.

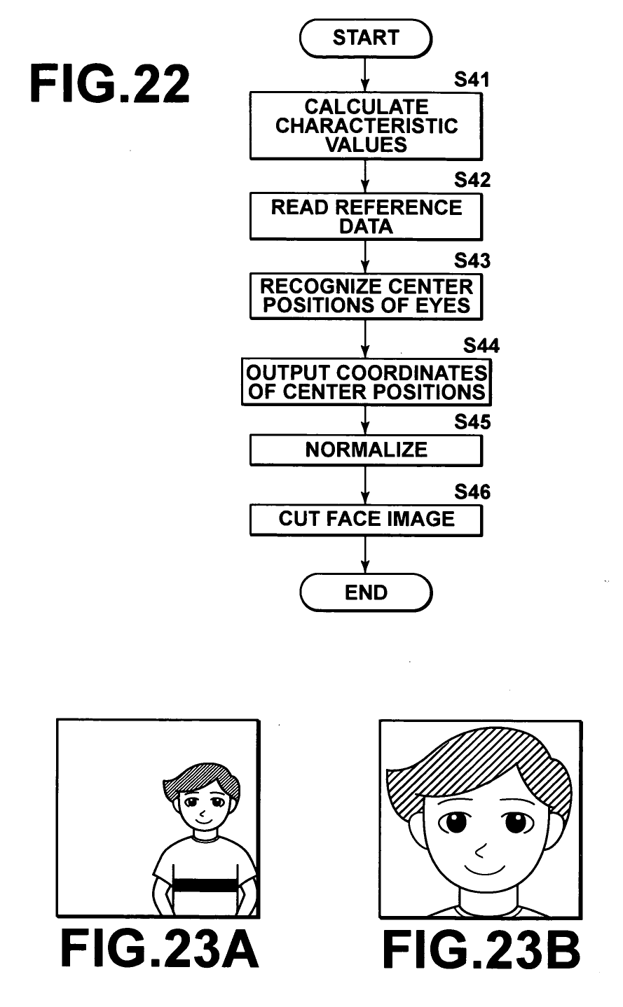

A procedure carried out according to an algorithm for cutting an area including face with reference to the center positions of eyes will be explained next. FIG. 22 is a flow chart showing the procedure carried out in the algorithm for cutting an area including face with reference to the center positions of eyes. The characteristic value calculation unit 131 in the eye position detection unit 121 calculates the characteristic values C0 as the directions and the magnitudes of the gradient vectors K of the original image S0 at all the steps of the enlargement or reduction and the rotation of the original image S0 (Step S41). The recognition unit 133 reads the reference data R1 from the memory 132 (Step S42), and recognizes the center positions of eyes in the original image S0 (Step S43). The output unit 134 outputs the coordinates of the center positions of eyes (Step S44).

The normalization unit 122 obtains the normalized original image S1 by normalizing the original image S0 so as to cause the distance D0 between the center positions of eyes to become the distance D1 (Step S45). The cutting unit 123 cuts the face image F0 having the predetermined format shown in FIG. 21 from the normalized original image S1 with reference to the distance D1 between the center positions of eyes in the normalized original image S1 (Step S46) to end the procedure.

As has been described above, by cutting the face image F0 having the predetermined format from the normalized original image S1 with reference to the distance D1 between the center positions of eyes in the normalized original image S1 generated through normalization of the original image S0 in such a manner that the distance between the center positions of eyes becomes the predetermined distance, the face image F0 having the same sizes can always be obtained regardless of a photography position of the person subjected to authentication. For example, if the face is not at the center of the original image S0 as shown in FIG. 23A, or if only the face is included fully in the original image S0 as shown in FIG. 23B, the face image F0 that can reproduce the image in the predetermined format can be obtained. Furthermore, the face image represented by the photographed face data F2 obtained by photography of the holder of the ID card 10 can have the predetermined format. In addition, even if the ID card 10 is not positioned accurately when the camera 53 photographs the face photo area 11 of the ID card 10, the face photo data F1 can be obtained for representing the face photo area 11 in the predetermined format. Therefore, even if the size or a position of the face in the original image S0 varies, the images of the same person cannot be identified as images of a different person. In this manner, troubles caused by necessity of accurate positioning of the person and the ID card 10 at the time of photography can be prevented.

In the above embodiment, the center positions of eyes are detected by using the result of machine learning. However, any method such as template matching using a template having a shape of eye can be use, as long as the method enables detection of the center positions of eyes.

Although the predetermined format is the format that generates the face image shown in FIG. 20 in this embodiment, the predetermined format is not necessarily limited to this format. Any format can be used, and the values of the parameters Sx, Sy1, and Sy2 for determining the trimming frame shown in FIG. 21 are determined according to the format.

What is claimed is:

1. An ID card generation apparatus comprising:
photography means for obtaining face photo data representing a face photo area of a predetermined format by photographing the face photo area in an ID card comprising the face photo area added with a face photo of the predetermined format and an information storage area for storing various kinds of information including personal information of the person of the face photo;
code conversion means for converting the face photo data into code information; and
code information recording means for storing the code information in the information storage area.

2. The ID card generation apparatus according to claim 1, wherein the face photo added to the face photo area is obtained by a face extraction apparatus comprising:
photography means for obtaining original image data representing an original image including the face of the person, the ID card of whom is being generated, by photographing the face;
eye position detection means for detecting center positions of eyes in the face in the original image;
normalization means for obtaining a normalized original image by normalizing the original image in such a manner that a distance between the center positions of the eyes that have been detected becomes a predetermined value; and
cutting means for obtaining face image data representing the face photo by cutting an image having the predetermined format from the normalized original image with reference to the distance between the center positions of the eyes in the face in the normalized original image.

3. The ID card generation apparatus according to claim 1, wherein the photography means comprises:
eye position detection means for detecting center positions of eyes in the face in an original image represented by original image data obtained by photographing the face photo area;
normalization means for obtaining a normalized original image by normalizing the original image in such a manner that a distance between the center positions of the eyes that have been detected becomes a predetermined value; and
cutting means for obtaining the face photo data by cutting an image having the predetermined format from the normalized original image with reference to the distance between the center positions of the eyes in the face in the normalized original image.

4. An ID card comprising:
a face photo area added with a face photo of a predetermined format; and
an information storage area for storing various kinds of information including personal information of the person in the face photo, wherein
the information storage area stores code information generated by converting face photo data that are obtained by photographing the face photo area and represents the face photo area of the predetermined format.

5. The ID card according to claim 4, wherein the face photo added to the face photo area is obtained by a face extraction apparatus comprising:
photography means for obtaining original image data representing an original image including the face of the person, the ID card of whom is being generated, by photographing the face;
eye position detection means for detecting center positions of eyes in the face in the original image;
normalization means for obtaining a normalized original image by normalizing the original image in such a manner that a distance between the center positions of the eyes that have been detected becomes a predetermined value; and
cutting means for obtaining face image data representing the face photo by cutting an image having the predetermined format from the normalized original image with reference to the distance between the center positions of the eyes in the face in the normalized original image.

6. A face authentication terminal comprising:
photography means for obtaining photographed face data representing a face image of a holder of the ID card in claim 4 in the predetermined format by photographing the face of the holder; and
information reading means for reading the personal information and the code information from the information storage area.

7. The face authentication terminal according to claim 6, further comprising display means for displaying various kinds of information including the photographed face data.

8. The face authentication terminal according to claim 6, further comprising:
registration means for registering personal information and code information of a large number of people;
information judgment means for carrying out judgment as to whether or not correlation personal information and correlation code information respectively corresponding to the personal information and the code information that has been read has been registered with the registration means;
code conversion means for converting the photographed face data into code information;
code judgment means for carrying out judgment as to whether or not the code information obtained by the code conversion means mostly agrees with the correlation code information; and
authentication information output means for outputting authentication information representing that the holder has been authenticated in the case where results of the judgment by the information judgment means and the code judgment means are both affirmative.

9. The face authentication terminal according to claim 6, wherein the photography means comprises:
eye position detection means for detecting center positions of eyes in the face in an original image represented by original image data obtained by photography of the face of the holder of the ID card;
normalization means for obtaining a normalized original image by normalizing the original image in such a manner that a distance between the center positions of the eyes that have been detected becomes a predetermined value; and
cutting means for obtaining the photographed face data by cutting an image having the predetermined format from the normalized original image with reference to the distance between the center positions of the eyes in the face in the normalized original image.

10. A face authentication apparatus comprising:
information acquisition means for obtaining the photographed face data, the personal information, and the code information obtained by the face authentication terminal in claim 6;
registration means for registering personal information and code information of a large number of people;
information judgment means for carrying out judgment as to whether or not correlation personal information and correlation code information respectively corresponding to the personal information and the code information that has been obtained has been registered with the registration means;
code conversion means for converting the photographed face data into code information;
code judgment means for carrying out judgment as to whether or not the code information obtained by the code conversion means mostly agrees with the correlation code information; and
authentication information output means for outputting authentication information representing that the holder has been authenticated in the case where results of the judgment by the information judgment means and the code judgment means are both affirmative.

11. A face authentication system comprising:
the face authentication terminal according to claim 6; and
a face authentication apparatus comprising:
information acquisition means for obtaining the photographed face data, the personal information, and the code information obtained by the face authentication terminal;
registration means for registering personal information and code information of a large number of people;
information judgment means for carrying out judgment as to whether or not correlation personal information and correlation code information respectively corresponding to the personal information and the code information that has been obtained has been registered with the registration means;
code conversion means for converting the photographed face data into code information;
code judgment means for carrying out judgment as to whether or not the code information obtained by the code conversion means mostly agrees with the correlation code information; and
authentication information output means for outputting authentication information representing that the holder has been authenticated in the case where results of the judgment by the information judgment means and the code judgment means are both affirmative, wherein
the face authentication terminal and the face authentication apparatus are connected to each other in a manner enabling transmission and reception of various kinds of information.

12. The face authentication system according to claim 11, further comprising the ID card generation apparatus in claim 1.
